(19) United States
(12) Patent Application Publication
(10) Pub. No.: US 2018/0357588 A1
(43) Pub. Date: Dec. 13, 2018

(54) SKILL DETECTION AND DETERMINATION

(71) Applicant: Microsoft Technology Licensing, LLC, Redmond, WA (US)

(72) Inventor: Akshay J D, Kozhikode (IN)

(21) Appl. No.: 15/994,600

(22) Filed: May 31, 2018

(30) Foreign Application Priority Data
Jun. 13, 2017 (IN) 201741020679

(51) Int. Cl. G06Q 10/06; G06F 8/71; G06F 8/41; G06F 8/36; G06F 17/30

(52) U.S. Cl. CPC G06Q 10/06398; G06F 8/71; G06F 17/30522; G06F 8/36; G06F 8/43

(57) ABSTRACT

Systems, methods, and computer-executable instructions for skill detection. An updated version of a file is received from a remote system. A change made in the updated version from a base version of the file is determined. The change associated with a user identifier. A user skill is determined based upon the change. A mapping of the user skill with the user identifier is stored.

### BACKGROUND

This application claims priority to Indian Application Serial Number 201741020679, filed Jun. 13, 2017, and titled “SKILL DETECTION AND DETERMINATION” the disclosure of which is incorporated herein by reference in its entirety.

### BACKGROUND

Skills and experience may be communicated via resumes and online web sites. These methods rely on users to provide the relevant skills and experience. With limited space, users may provide high level summaries of their skills rather than a longer more detailed list. Thus, finding users with specific skill, experience with particular features of a program, or experience with a programming language may be frustrated. In addition, users may over emphasis some experience over other experiences.

### BRIEF DESCRIPTION OF THE DRAWINGS

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

FIG. 1 is a diagram of learning skills of users in accordance with respective examples.

FIG. 2 is a flow diagram of a process flow of skill detection in accordance with respective examples.

FIG. 3 is an example computing device that can be used in conjunction with the technologies described herein.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail.

In accordance with techniques described herein, skills, experience, and features associated with a user are determined and stored. A user skill may indicate the user's experience with various features of a software program, experience using particular methods, libraries, frameworks, etc., and/or more general experience. After a user edits or modifies a file, the changes from a previous version are determined. The changes are then used to determine the skills associated with the user. For example, for a source code file, a user changing an original method call to a new method call associated with a framework would indicate the user has experience with the framework. In an example, the user may make a method call to a networking framework to open a port to a remote server. The change between the previous version and the updated version indicates the user changed the file to call the method to open the port. What library and/or framework the user has experience with may then be determined using the method name. In another example, a variable created by the user and determined from the changes may be used. The variable type may be used to determine the framework and/or library with which the user has experience. A user identifier may be used to uniquely identify a user. The feature along with the user identifier may be stored.

The amount of experience a user has with a framework may be determined based upon multiple changes across multiple files. For example, if a user uses a security library across multiple different files and/or projects, the number of times the security library is used by the user may be stored. In addition, a timestamp of when a feature is used may be stored. The timestamp may be used to determine how long and/or how consistently a user uses a particular feature, library, framework, etc. Determining and storing the skills, experience and features known by a user based upon the user's work and without requiring the user to input data would be useful. The user information may be indexed, allowing managers, companies, co-workers to search for users with particular skills, experience, and features.

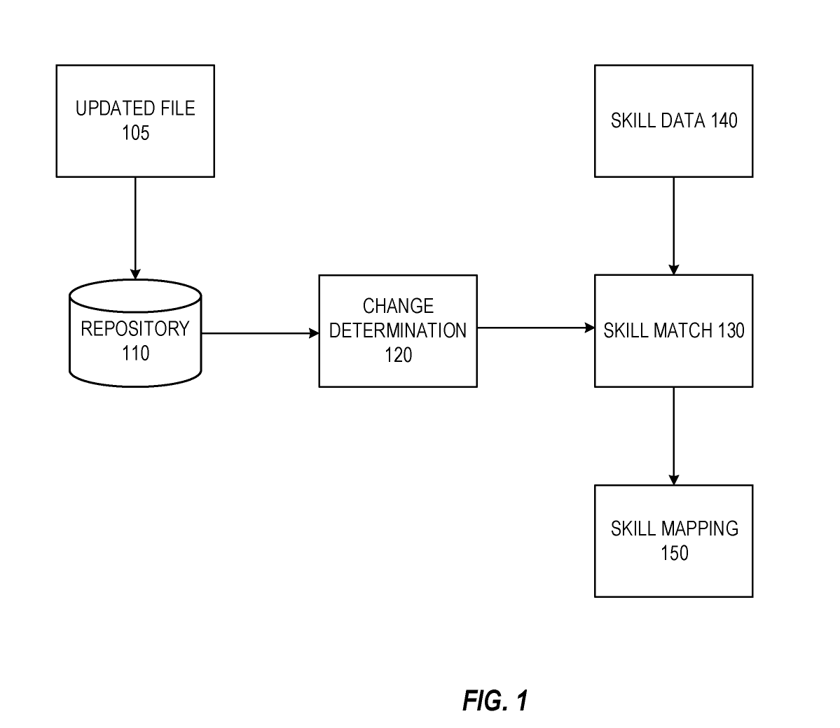

FIG. 1 is a flow diagram of learning skills of users in accordance with respective examples. A repository 110 may be used to store files. The repository may be a version control repository that stores different versions of the same file. In an example, the repository 110 acts a simple file store without any versioning features. A file may be checked out or downloaded by a user. The user may edit and change the file. In an example, the repository 110 stores source code files. Each source code file may be downloaded and changed by a user. Once the editing is done, the updated file may be checked in or uploaded to the repository 110.

In an example without versioning features, change determination 120 may take place when the updated file is uploaded. The original file may be saved and the differences between the original and the updated files may be determined. In an example, the changes are determined and then the uploaded file is copied over the original file.

In an example with versioning features, the uploaded file may be checked into the repository 110. The changes 120 between the updated file and the original version may be determined any time since both versions of the file may be saved in the repository. For subsequent change determinations, the newly uploaded file may be considered the “original file.”

In an example using source code files, the change determination first determines the portions of the file that were modified. For example, a diff program between the original version and the updated version may be used. Once the differences are determined, the differences may be parsed looking for method calls, library calls, and/or variable types. The method calls, library calls, and/or variable types may be used to determine the skills 130 used by the user. The skills 130 may be matched against skills data 140. The skill data may include a listing of methods, libraries, variable types, etc., mapped to a higher-level group. For example, a method may be matched to a particular framework or a technology. In an example, a particular method call or variable type is defined within a library. The library may be part of a framework, such as a networking or security framework. If the changes made by the user added the method call or a variable of the variable type, the user may match the networking or security framework. In addition, the changes may indicate the user has general networking or security experience. This mapping may be captured as a skill mapping 150 that may be stored in a database.

The skill database may then be searched at a later date. For example, the skill database may be searched for users with a particular skill. In an example, a manager may search for co-workers that have experience with a particular framework, method call, library, etc. The skills database may also be used to populate a resume or add to a user profile on various websites.

In an example, the skill mapping includes a timestamp as to when the user used a skill. In addition, the number of times the user used a skill may also be stored. This allows for searching for users that have used a skill for a specific period of time or a specific number of instances. For example, a search may be conducted that searches for users that have at least one year of experience using a networking framework and have used the networking framework at least six times in the last year.

The updated file 105 may also provide an indication as to which features of a software program were used. In an example, the file may stored in a markup language. The differences in the markup language between the original file and the uploaded file may indicate the software features used by the user. For example, a file from a spreadsheet application may indicate the various features used by the user when editing a file. In an example, a user may add a macro or edit an existing macro. Analyzing the changes to AN updated file allows the matching of a general macro feature, a specific type of macro, or a specific type of variable used in the macro, etc. Other features may include using formatting, using mathematical formulas, editing page size, using headers/footers, etc. As a user uses more and more features, the skill database provides an opportunity to determine both features used and features not used by the user. In an example, the user may be offered a software license to the software program based upon the used features. The software license may cost less based on the features used while the unused features would not be licensed. In an example, a group of users may be used to determine the license for the entire group rather than a single user.

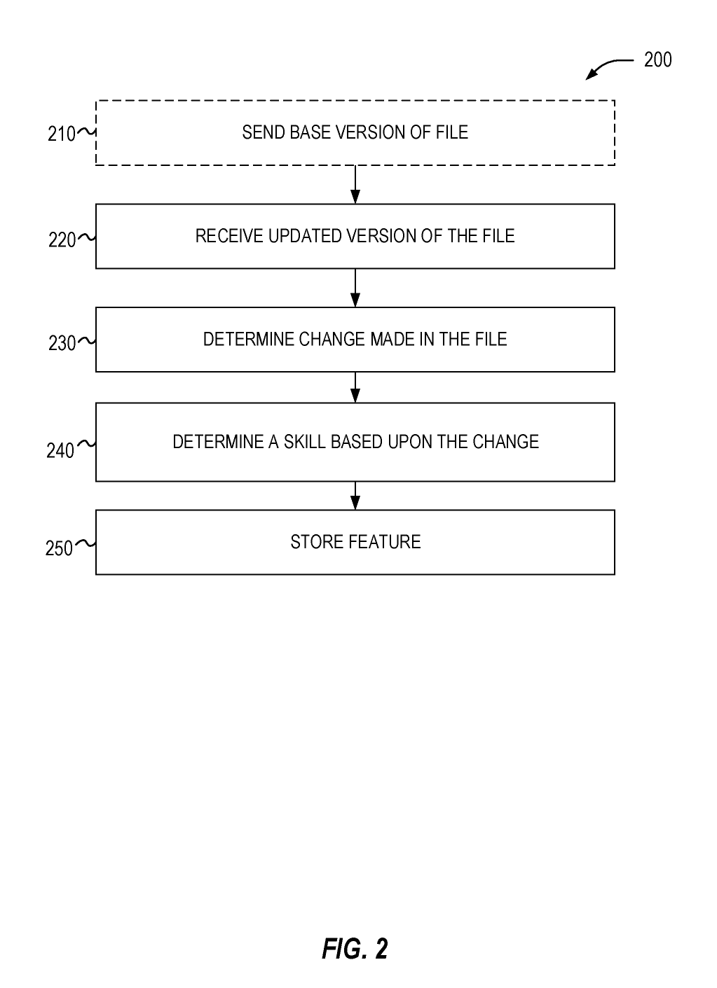

FIG. 2 is a flow diagram of a process flow 200 of skill detection in accordance with respective examples. The process flow 200 may be implemented using a computing system. At 210, a base version of a file may be sent to a computing system. Sending the base version is optional. In an example, a user may request to check out or edit a new file. Editing a new file is an example where a base version may not be sent to the user. If the file already exists, for example as a source code file in a versioning repository, a base version of the file is sent. The base version of the file may be any version of the file that is stored within the versioning repository. The user that has requested the file may have the ability to edit and change the file.

The updated file may be checked back into the file repository system. At 220, the updated version of the file is received. A user identifier may be associated with the file that indicates the user that made the changes to the file. For example, a user identifier may be stored when the user check outs the file. At 230, changes made between the base version and the updated version are determined. If there is no base version, then the entire contents of the updated file are determined to be the changes. If a base version exists, differences between the base version and the updated version may be determined. These differences indicate the changes that the user made to the base version. The base version of a file is the file prior to any user edits. The comparison between an updated file and its corresponding base version, therefore, indicates changes made by the user.

At 240, a feature associated with the changes is determined. In an example, various libraries and/or frameworks may have previously been mined for method calls, library calls, variable types, namespaces, etc. The various calls, types, etc., may be associated with one or more features. In addition, comments, documentation, and/or wikis may be embedded within or associated with the libraries and/or frameworks. The comments and/or documentation may also be mined for possible features.

As an example of a feature, a database method call may be mapped to a general database feature, a specific database library feature, a database framework, and/or a specific method call. As another example, a particular variable or parameter to a method call may be used to identify a feature. For example, a database connection variable may indicate a specific type of database with which a user has experience. In addition, the variable may also indicate specific database features that the user has experience. Continuing with this example, a user may change source code that connects to a database directly to use a database framework call. This change may indicate that the user is both familiar with databases but also experienced with using the database framework and using the framework rather than direct calls to connect to the database. As another example, a change may include a variable type. The library that defines the variable type may be determined to be the identified feature.

At 250, a mapping between the user identifier and identified feature are stored. For example, the mapping may be stored in a database. The changes or a pointer to the changes may also be saved. Storing the changes allows for retrieving the code or changes relevant to the identified feature.

The database may be used to search for users that have specific experience. For example, a search query that identifies one or more features may be used to search the database. User identifiers that match the search query may be returned. This allows searching for users with specific experience using a method, library, framework, variable type, database, etc. In an example, the search may also include a length of time the user has been using the method, library, framework, variable type, database, etc. In an example, the search may be for users that have database experience and use the database framework. In addition, the user may have at least six months of the database experience. The search may be further enhanced by indicating that the user must have used the database experience at least six times in the last three months.

The database may also be used as a way to find users that may be able to help solve a problem. If a first user is having trouble connecting to a remote server using a networking framework, the first user may search for other users that have successfully used the networking framework. The first user may then be directed to code changes made by other users that use the networking feature. In addition, the first user may be able to contact the other users to ask questions directly.

The database may also be used to determine which features of a software program that the user uses. For example, the updated file may be a word processing document, spreadsheet document, presentation document, etc. The file may include an indication of the various features used in editing the document. For example, changes made by a user may indicate that the user has macro experience, has advanced formatting experience, has add-in experience, etc. The various used features may be stored in the database. These features may then be used to determine all of the features that a particular user or users have used. From a list of all available features, a list of all unused features may also be determined. Using either all of the used features or both the used and unused features, an appropriate license may be determined for the user. An appropriate license is one that covers all the used features without including all the unused features.

The used and unused features may also be used to determine training or help appropriate for the user. For example, a user that uses direct server calls rather than a framework may be identified. Providing training and benefits of using a framework to make server calls may be provided to the user. As another example, a user that does not use particular features, e.g., mathematical formula editing, may be identified. The changes associated with the user may also indicate that the user is using some mathematical notation using font features. An explanation video or text of a mathematical formula editor may be provided to the user.

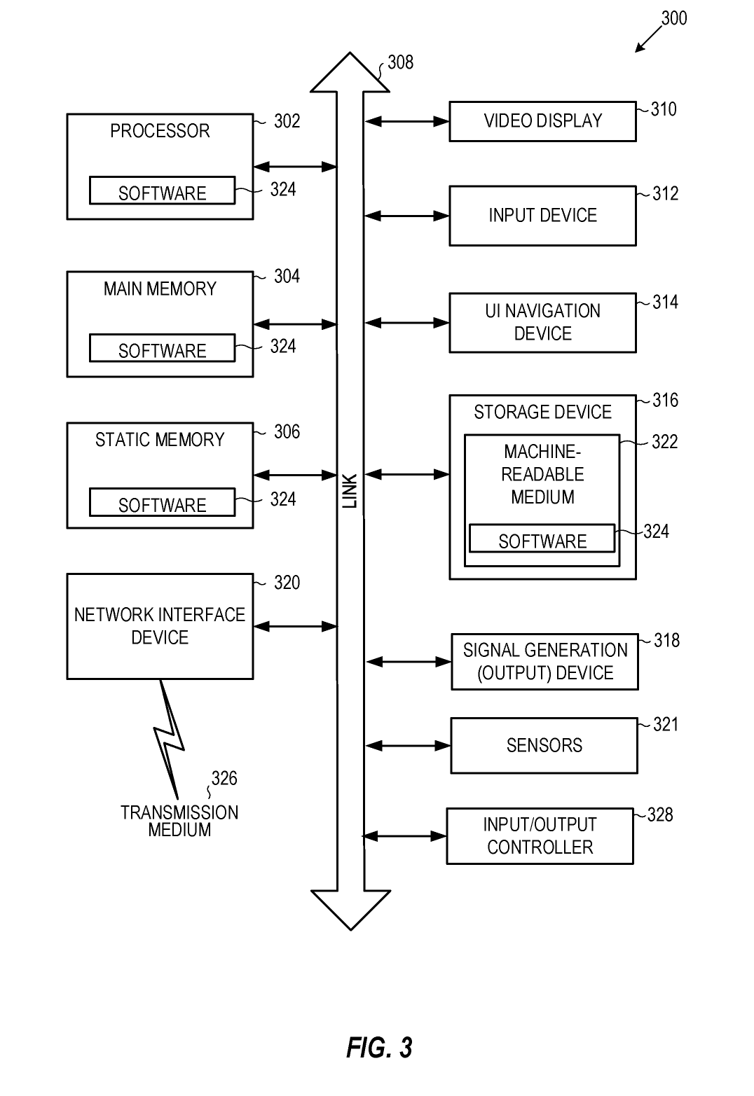

FIG. 3 is an example computing device that can be used in conjunction with the technologies described herein. In alternative embodiments, the computing device 300 may operate as a standalone device or may be connected (e.g., networked) to other computing devices. In a networked deployment, the computing device 300 may operate in the capacity of a server communication device, a client communication device, or both in server-client network environments. In an example, the computing device 300 may act as a peer computing device in peer-to-peer (P2P) (or other distributed) network environment. The computing device 300 may be a personal computer (PC), a tablet PC, a set top box (STB), a personal digital assistant (PDA), a mobile telephone, a smart phone, a web appliance, a network router, switch or bridge, or any computing device capable of executing instructions (sequential or otherwise) that specify actions to be taken by that computing device. Further, while only a single computing device is illustrated, the term “computing device” shall also be taken to include any collection of computing devices that individually or jointly execute a set (or multiple sets) of instructions to perform any one or more of the methodologies discussed herein, such as cloud computing, software as a service (SaaS), other computer cluster configurations.

Computing device 300 may include a hardware processor 302 (e.g., a central processing unit (CPU), a graphics processing unit (GPU), a hardware processor core, or any combination thereof), a main memory 304 and a static memory 306, some or all of which may communicate with each other via an interlink (e.g., bus) 308. The computing device 300 may further include a display unit 310, an input device 312 (e.g., a keyboard), and a user interface (UI) navigation device 314 (e.g., a mouse). In an example, the display unit 310, input device 312, and UI navigation device 314 may be a touch screen display. In an example, the input device 312 may include a touchscreen, a microphone, a camera (e.g., a panoramic or high-resolution camera), physical keyboard, trackball, or other input devices.

The computing device 300 may additionally include a storage device (e.g., drive unit) 316, a signal generation device 318 (e.g., a speaker, a projection device, or any other type of information output device), a network interface device 320, and one or more sensors 321, such as a global positioning system (GPS) sensor, compass, accelerometer, motion detector, or another sensor. The computing device 300 may include an input/output controller 328, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.) via one or more input/output ports.

The storage device 316 may include a computing-readable (or machine-readable) storage media 322, on which is stored one or more sets of data structures or instructions 324 (e.g., software) embodying or utilized by any one or more of the techniques or functions described herein. In an example, at least a portion of the software may include an operating system and/or one or more applications (or apps) implementing one or more of the functionalities described herein. The instructions 324 may also reside, completely or at least partially, within the main memory 304, within the static memory 306, and/or within the hardware processor 302 during execution thereof by the computing device 300. In an example, one or any combination of the hardware processor 302, the main memory 304, the static memory 306, or the storage device 316 may constitute computing device (or machine) readable media.

While the computer-readable storage media 322 is illustrated as a single medium, a “computer-readable storage media” or “machine-readable storage media” may include a single medium or multiple media (e.g., a centralized or distributed database, and/or associated caches and servers) configured to store the one or more instructions 324.

In an example, a computer-readable storage media or machine-readable storage media may include any medium that is capable of storing, encoding, or carrying instructions for execution by the computing device 300 and that cause the computing device 300 to perform any one or more of the techniques of the present disclosure, or that is capable of storing, encoding or carrying data structures used by or associated with such instructions. Non-limiting computer-readable storage media examples may include solid-state memories, and optical and magnetic media. Specific examples of computer-readable storage media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and optical media disks. The computer-readable storage media is non-transitory in that the storage media does not consist of transitory propagating signals.

The instructions 324 may further be transmitted or received over a communications network 326 using a transmission medium via the network interface device 320 utilizing any one of several transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.8 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. The network interface device 320 may use the transfer protocols to transmit data using transitory propagating signals.

In an example, the network interface device 320 may include one or more physical jacks (e.g., Ethernet, coaxial, or phone jacks) or one or more antennas to connect to the communications network 326. In an example, the network interface device 320 may include one or more wireless modems, such as a Bluetooth modem, a Wi-Fi modem or one or more modems or transceivers operating under any of the communication standards mentioned herein. In an example, the network interface device 320 may include a plurality of antennas to wirelessly communicate using at least one of single-input multiple-output (SIMO), multiple-input multiple-output (MIMO), or multiple-input single-output (MISO) techniques. In some examples, the network interface device 320 may wirelessly communicate using Multiple User MIMO techniques. In an example, a transmission medium may include any intangible medium that is capable of storing, encoding or carrying instructions for execution by the computing device 300, and includes digital or analog communications signals or like communication media to facilitate communication of such software.

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

The above description is intended to be illustrative, and not restrictive. For example, the above-described examples (or one or more aspects thereof) may be used in combination with others. Other embodiments may be used, such as by one of ordinary skill in the art upon reviewing the above description. Further, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1. A method for skill detection, the method comprising:
receiving an updated version of a file from a remote system;
determining a change made in the updated version from a base version of the file, the change associated with a user identifier;
determining a user skill based upon the change; and
storing, in a database, a mapping of the user skill with the user identifier.

2. The method of claim 1, further comprising:
for each version of a plurality of files in a repository:
determining changes between the version and a corresponding base version;
determining a change user identifier associated with the changes;
determining second user skills based upon the changes; and
storing, in the database, a mapping of the second user skills with the change user identifier.

3. The method of claim 1, further comprising:
receiving a search query comprising a sought skill;
searching the database for the sought skill; and
returning the user identifier based upon matching the sought skill with the user skill.

4. The method of claim 1, further comprising sending the base version of a file to the remote system.

5. The method of claim 1, wherein the file comprises source code and the change comprises a method call.

6. The method of claim 5, further comprising:
searching for a framework that comprises the method call, wherein the user skill is using the framework.

7. The method of claim 1, wherein the file comprises source code and the change comprises a library reference, wherein the user skill is using the library.

8. The method of claim 1, wherein the file comprises source code and the change comprises a variable, the method further comprising:
determining a variable type of the variable; and
determining a library that defines the variable type, wherein the user skill is using the library.

9. The method of claim 1, further comprising determining used features of a software program associated with the change.

10. The method of claim 9, further comprising:
determining used features of the software program from the mapping;
determining unused features of the software program from the mapping; and
determining a license based upon all the used features and the unused features.

11. A system for skill detection, the system comprising:
a processing unit configured to perform operations comprising:
receiving an updated version of a file from a remote system;
determining a change made in the updated version from a base version of the file, the change associated with a user identifier;
determining a user skill based upon the change; and
storing, in a database, a mapping of the user skill with the user identifier.

12. The system of claim 11, the operations further comprise:
receiving a search query comprising a sought skill;
searching the database for the sought skill; and
returning the user identifier based upon matching the sought skill with the user skill.

13. The system of claim 11, wherein the file comprises source code and the change comprises a method call.

14. The system of claim 13, the operations further comprise searching for a framework that comprises the method call, wherein the user skill is using the framework.

15. The system of claim 11, wherein the file comprises source code and the change comprises a variable, the operations further comprise:
determining a variable type of the variable; and
determining a library that defines the variable type, wherein the skill is using the library.

16. The system of claim 11, further comprising determining used features of a software program associated with the change.

17. The system of claim 16, further comprising:
determining used features of the software program from the mapping;
determining unused features of the software program from the mapping; and
determining a license based upon all the used features and the unused features.

18. A non-transitory computer-readable storage media storing computer-executable instructions for skill detection, the stored instructions comprising:
instructions to receive an updated version of a file from a remote system;
instructions to determine a change made in the updated version from a base version of the file, the change associated with a user identifier;
instructions to determine a user skill based upon the change; and
instructions to store, in a database, a mapping of the user skill with the user identifier.

19. The non-transitory computer-readable storage media of claim 18, the instructions further comprise:
instructions to receive a search query comprising a sought skill;
instructions to search the database for the sought skill; and
instructions to return the user identifier based upon matching the sought skill with the user skill.

20. The non-transitory computer-readable storage media of claim 18, wherein the file comprises source code and the change comprises a method call.
